(19) United States
(12) Patent Application Publication
(10) Pub. No.: US 2023/0131366 A1
(43) Pub. Date: Apr. 27, 2023

(54) COMPUTER-IMPLEMENTED METHOD FOR COMPLETING AN IMAGE

(71) Applicant: Sony Interactive Entertainment Europe Limited, London, Greater London (GB)

(72) Inventors: Andrew James Bigos, London (GB); Daniel Goldman, London (GB); Cristian Craciun, London (GB)

(73) Assignee: Sony Interactive Entertainment Europe Limited, London, Greater London (GB)

(21) Appl. No.: 17/921,017

(22) PCT Filed: Apr. 23, 2021
(86) PCT No.: PCT/GB2021/050991

§ 371 Date: Oct. 24, 2022

(30) Foreign Application Priority Data
Apr. 24, 2020 (GB) 2006051.3

(51) Int. Cl. G06T 5/00; G06T 5/30; G06T 7/00; G06T 7/60

(52) U.S. Cl. CPC G06T 5/005; G06T 5/30; G06T 7/0002; G06T 7/60; G06T 2207/20021; G06T 2207/20084

(57) ABSTRACT

The present disclosure relates to a computer-implemented method for completing an image, the method comprising the steps of dividing data of an image to be completed into a plurality of image portions. The method entails applying a first filling process to fill a first image portion comprising a first hole, the first hole associated with a first quantity and/or a first quality; and applying a second filling process to fill a second image portion comprising a second hole, the second hole associated with a second quantity different to the first quantity and/or a second quality different to the first quality, the second process being different to first process. The method then includes combining the filled first and second image portions to complete the image.

### INTRODUCTION

The present disclosure relates to a computer-implemented method for completing an image and a computer device configured to carry out the method. The present disclosure relates particularly to detecting, categorising, and filling holes in an image according to the categorisation.

### BACKGROUND

Digital images can contain regions of missing or corrupted image data. Missing or corrupted regions are referred to in the art as “holes”. Holes are normally undesirable, and methods of inferring what information is missing or corrupted are employed to fill the holes. Filling holes in images is also referred to as image completion or inpainting.

A variety of processes exist for filling holes in images. Machine learning inference techniques, which rely on trained processes, can fill holes in images with high-quality results. However, machine learning techniques are performance intensive, requiring powerful computer hardware and a large amount of time.

Holes in images arise in image-based rendering systems. For example, where there are two or more images representing perspectives of the same environment, there may be no image data corresponding to an intermediate perspective that a user would like to see. Alternatively, there may be some image data missing from one of the perspectives. Machine learning processes may be used to infer the intermediate perspective and to infer the missing image data. Executing machine learning processes to obtain missing data is computationally costly and time consuming.

An example of an image-based rendering system is a virtual reality device displaying a virtual reality environment. A user wearing a virtual reality headset is presented, by two monitors in the headset, with a representation of a three-dimensional scene. As the user moves their head, a new scene is generated and displayed according to the new position and orientation of the headset. In this way, a user can look around an object in the scene. Areas of the initial scene which become visible in the new scene due to the movement are described as being previously “occluded”.

The displayed scenes may be generated by computer hardware in a personal computer or console connected to the headset, or by a cloud-based rendering service remote from the headset. A rate at which image data is supplied to the headset is limited by bandwidth of the connection between the headset and the computer, console, or the cloud-based rendering system. Consequently, sometimes, not all the data required at a given time to entirely construct and display a scene is available due to bandwidth limitations or interruptions. Holes in the image data making up the scene are an undesired result and have a significant negative impact on the immersion experienced by the user.

### SUMMARY AND STATEMENTS OF THE PRESENT DISCLOSURE

According to a first aspect of the present disclosure, there is provided a computer-implemented method for completing an image, the method comprising: dividing image data of an image to be completed into a plurality of image portions; applying a first filling process to fill a first image portion comprising a first hole, the first hole associated with a first quantity and/or a first quality; applying a second filling process to fill a second image portion comprising a second hole, the second hole associated with a second quantity different to the first quantity and/or a second quality different to the first quantity and/or quality, the second process being different to first process; and combining the filled first and second image portions to complete the image.

A hole of the received image data may correspond to an occluded area.

The computer-implemented method may comprise generating a mask of the image to be completed, performing at least one morphological operation on the mask to generate an altered mask, and determining to apply the first filling process and the second filling process based on respective first and second quantities and/or qualities of the altered mask.

By generating an altered mask, holes are more quickly identifiable as having particular qualities and/or quantities, which makes categorising the holes based on the qualities/quantities faster and more versatile.

The computer implemented-method may comprise determining to apply the first filling process on a first hole based on an absence of a hole corresponding to the first hole in the altered mask, and determining to apply the second filling process on a second hole based on a presence of a corresponding hole in the altered mask.

By determining to apply the first filling process based on absence of a hole in the altered mask, and the second filling process based on presence of a hole in the altered mask, a particularly simple categorisation is provided which enables yet faster categorisation of holes to be filled. Thereby, comparatively less powerful computers are made able to perform the method to obtain better quality images more quickly.

The at least one morphological operation may include erosion and/or dilation.

A (first or second) quantity associated with a hole may be the hole size or shape or one or more dimensions associated with the holes that may be numerically quantified. In some examples this may be the number of pixels that may be associated with the hole. A (first or second) quality may be one or more features such as pixel resolution, brightness etc. of the hole.

By dividing image data into image portions, and applying different filling processes to the tiles depending on a quantity and/or quality associated with holes in the tiles, the method advantageously reduces the proportion of the image that requires any processing to remove holes and is more versatile, scalable and adaptable to filling holes in a variety of different images.

The computer-implemented method may comprise applying the first filling process to the first image portion in response to a determination that the first hole has a dimension smaller than a first threshold value.

The computer-implemented method may comprise applying the second filling process to the second image portion in response to a determination that the second hole has a dimension larger than a second threshold value.

This advantageously allows holes having smaller dimensions to be processed differently to those with larger dimensions, further increasing the versatility of the method when processing images with a range of hole dimensions.

The first filling process may include filling a pixel of a hole of the first type according to an average of surrounding pixels.

This advantageously provides a fast and computationally inexpensive way of filling a hole.

The computer-implemented method may comprise determining the average using surrounding pixels having a material identification which is the same as the pixel to be filled.

This advantageously enables the hole to be filled quickly and efficiently, while increasing the likelihood of achieving a high-quality result. Nearby pixels having different material identifiers to the hole pixel are more likely to look different to the missing pixel data, than those with matching material identifiers. Therefore, using pixels with the same material identifiers advantageously reduces the computational burden on a processor, while more closely achieving an appropriately filled pixel.

The determination of the average may include weighting values of the surrounding pixels to be averaged.

This enables some surrounding pixels to contribute more to the average than others, thereby advantageously increasing the versatility of the filling process according to the image being processed.

The second filling process may include a machine learning inference process.

Machine learning inference processes provide high quality image filling results. By providing a machine learning inference process as the second filling process, advantageously an improved balance between speed and quality of image processing is achieved.

The computer-implemented method may comprise combining the filled image portions with image portions that were not filled by the first and second processes.

This provides the advantage of reconstructing a complete image without needing to process image portions that do not contain holes, thereby advantageously increasing the speed of the method.

According to a second aspect of the present disclosure, there is provided a computing device comprising one or more processors that are associated with a memory, the one or more processors configured with executable instructions which, when executed, cause the computing device to carry out any computer-implemented method described above.

The computing device may be configured to receive image data of an image to be completed from a server. The server may be a cloud-based image rendering server. The computer device may be configured to receive data of an image to be completed from an image capture device, or from a processor associated with the image capture device.

Advantageously, filling holes in occluded areas reduces the reliance on receiving all rendered data corresponding to the occluded areas when the occluded areas become visible, thereby reducing the load on the computer device doing the rendering.

The computing device may be a virtual reality device. The virtual reality device may be a virtual reality headset.

Virtual reality headsets require much higher computing power to display a satisfactory image to a user than a conventional computer monitor. This is because the monitors of a virtual reality headset are much closer to a user's eyes, subtend a much larger angle, and operate at a higher and sustained frame rate. Providing a virtual reality headset configured according to the method as described above provides the advantage of requiring much less computing power without sacrificing image quality where it is needed most for maintaining user comfort and immersion.

### BRIEF DESCRIPTION OF THE ACCOMPANYING FIGURES

Embodiments of the present disclosure will now be described, by way of example only and not in any limitative sense, with reference to the accompanying drawings, in which:

FIG. 1 is a flow chart illustrating steps of a method embodying the present disclosure according to one embodiment;

FIG. 2 is a flow chart illustrating steps of a method embodying the present disclosure according to another embodiment;

FIG. 2a is an example illustration of the inputs as well as the output associated with a trained data model for implementing embodiments of the present disclosure;

FIG. 3a shows a kernel used in an embodiment of the present disclosure;

FIG. 3 illustrates a process for processing image data into a completed image according to an embodiment of the present disclosure;

FIG. 4 illustrates a process for processing image data into a completed image according to an embodiment of the present disclosure;

FIG. 5 shows an image containing holes;

FIG. 6 shows a mask of the image of FIG. 5;

FIG. 7 shows a mask of the image of FIG. 5 after a processing step according to an embodiment of the present disclosure;

FIG. 7A illustrates a process for processing image data into a completed image according to an embodiment of the present disclosure;

FIG. 8 shows the image of FIG. 5 divided into image portions according to an embodiment of the present disclosure;

FIG. 9 shows the image of FIG. 5 divided into image portions and after a processing step according to an embodiment of the present disclosure;

FIG. 10 shows an image divided into image portions and categorised according to an embodiment of the present disclosure; and

FIG. 11 is a schematic illustration of a computing device for implementing one or more aspects, embodiments or processes of the present disclosure.

### DETAILED DESCRIPTION

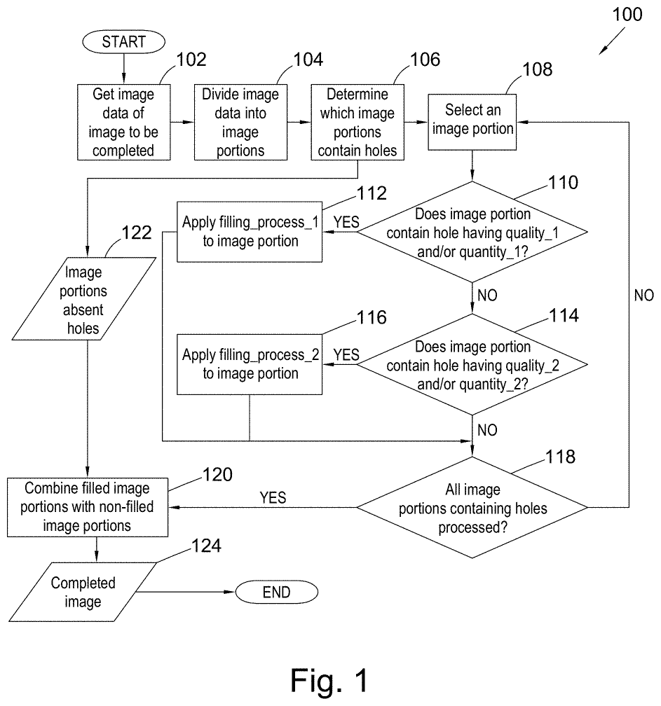

Referring to FIG. 1, a method (100) for completing an image according to an embodiment will now be described.

Generated image data of an image to be completed is received (102) by one or more computer devices configured to carry out the method. The image data may have been rendered by the same or a different, remote computer device. Herein, “image data” refers to any data which is interpretable by computer software for display of an image to a user.

In an embodiment, the computer device is a personal computer, console, a server such as a cloud-based image rendering server, or an image capture device or processor thereof. Image capture devices include cameras and suchlike. Image capture devices may be mounted on an exterior of a virtual reality headset and configured to pass captured image data to the virtual reality headset or to computer hardware in communication with the virtual reality headset.

In an embodiment, images are displayed on screens inside a virtual reality headset. A virtual reality headset includes a pair of monitors for displaying image data to a user. The image data is rendered in a distorted manner so that, when displayed on the monitors, light from the monitors refracts through lenses of the headset to the user's eyes in such a way that the user perceives a three-dimensional environment. The virtual reality headset may include motion detection hardware so that motion of the user, and therefore motion of the headset, is provided as input data to a process running either on computer hardware of the headset or on computer hardware in communication with the headset, the process configured to update the image data in accordance with the motion.

The image data is divided (104), or split, into image portions. From herein after, image portions will be referred to as tiles. The number of tiles is chosen based on the capabilities of the computer and/or the network to which the computer is connected. For example, the tiles size may be 256×256 pixels, or 128×128 pixels, or any other size deemed suitable. Aspect ratios of other than 1:1 are possible. Handling and processing of larger tiles requires more powerful processors and more memory. Smaller tiles may lack contextual information required to produce a high-quality filling result. A tile size and shape are therefore chosen according to the hardware constraints.

In an embodiment, the method may be adapted to include identifying the locations of holes and divide the image data into tiles such that the boundaries of the tiles do not intersect the holes. This reduces the number of tiles which need to be processed to fill the holes as the holes will not be spread over several tiles. This will require taking into account the amount of contextual information required from surrounding pixels to effectively inpaint a hole, and the capabilities of the computer hardware configured to implement the inpainting method (such as the capabilities of a GPU to processes several tiles at once).

The tiles are examined to determine (106) which tiles contain missing data to be completed, corrupted data to be replaced, or undesirable data that is to be replaced. From herein after, the parts of an image where the image data is missing, corrupted, or undesirable, will be referred to as “holes”.

If a tile is categorised as absent any holes, the image data of that tile is not passed to computing device associated with a processor configured for implementing one or more filling processes on the image data. Instead, the image data of that tile is stored for subsequent combination with processed tiles into a complete image, as will be described below.

A tile determined to contain a hole is selected (108).

The computer device determines a quantity and/or quality associated with the hole. If the hole is determined (110) to have a first quality and/or a first quantity associated with it, then the tile is categorised as a first type tile and a filling process of a first type is chosen for filling (112) the hole in the tile. If the hole is determined (114) to have a second quality and/or quantity associated with it, then the tile is categorised as a second type tile and a filling process of a second type is chosen for filling (116) the hole in the tile.

In FIG. 1, the first quality is referred to as quality_1, the first quantity as quantity_1, the filling process of the first type as filling_process_1, the second quality is referred to as quality_2, the second quantity as quantity_2, and the filling process of the second type as filling_process_2.

The selected tile is passed as input to one of the two filling processes in accordance with its categorisation.

It should be noted that, although there are two qualities and/or quantities and two filling processes described in this embodiment, it is within the scope of the disclosure for there to be more than two quantities and/or qualities and more than two respective types of filling process, depending on how complex the method is desired to be.

Once it has been determined (118) that all the tiles that contain holes have had their holes filled by one of the filling processes, then the filled tiles are reconstituted to form a complete image (120). If there are tiles (122) that do not contain any holes, and therefore were not passed to a filling process for filling, these are combined with the tiles that were filled to form the complete image (124).

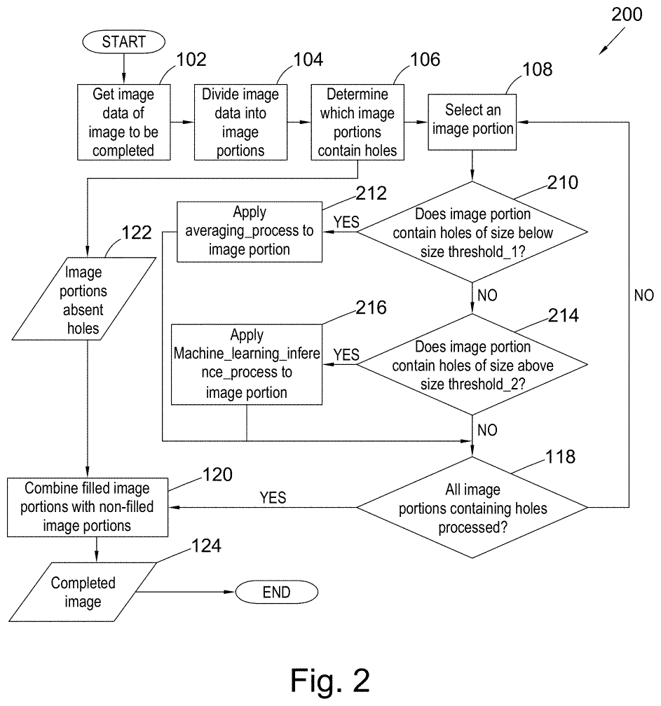

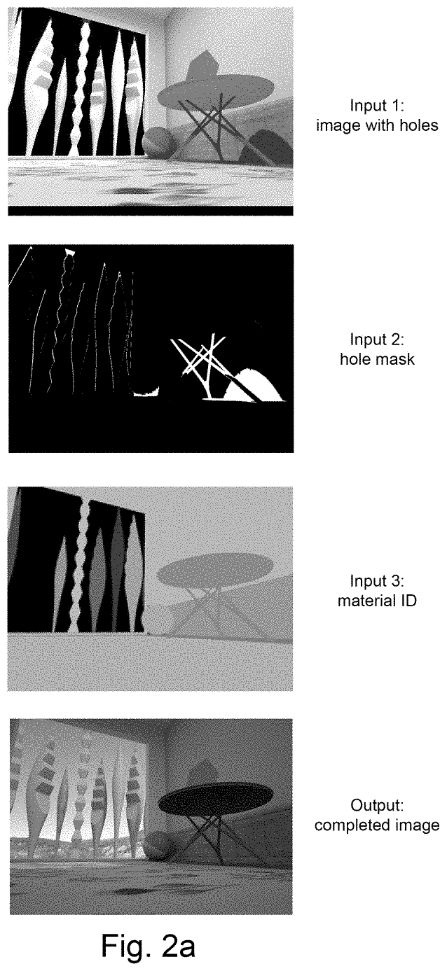

Referring to FIG. 2, a method (200) for completing an image according to another embodiment will now be described. The method of FIG. 2 is similar to that of FIG. 1, where differences are marked with like numerals increased by 100.

In this embodiment, first and second quantities relate to a size of a hole in a tile. The size of the hole in the tile may be determined by determining the number of pixels of the tile that define the hole (from herein after referred to as hole pixels) and comparing the total number to a pre-determined threshold value.

If the total number of hole pixels is determined (210) to be less than a pre-determined value, the tile is categorised as a “small hole” tile. In FIG. 2, this threshold value is referred to as “size_threshold_1”.

If the total number of hole pixels is determined (214) to be greater than the threshold value, the tile is categorised as a “large hole” tile. In FIG. 2, this threshold value is referred to as “size_threshold_2”.

It is to be noted that where “greater than” and “less than” are used, it is instead possible to use “greater than or equal to” or “less than or equal to”.

A size threshold could include a length of a hole along a principal axis, a width of a hole transverse to a principal axis, a combination thereof, or a ratio of length to width. Additionally or alternatively to a size threshold, a smoothness or roughness threshold may be used which corresponds to a threshold value of hole edge smoothness or roughness respectively.

The tiles containing holes are thereby categorised according to the sizes of the holes that the tiles contain. Tiles that do not contain any holes may be categorised accordingly.

Image data of each tile is then passed as input to a filling process depending on the categorisation of the tile.

If the tile is categorised as a “small hole” tile, the image data of that tile is passed to a first filling process, i.e. an image filling process of a first type, that is not associated with machine learning, i.e. does not utilise data model to make predictions, such as an artificial neural network (ANN). This is herein after referred to as a first process for processing. In FIG. 2, as an example of a first process, an “averaging_process” is implemented by one or more processors. The first process fills (212) the hole and outputs processed image data corresponding to a filled version of the small hole tile.

The first process may include selecting a hole pixel, computing an average of pixels surrounding the hole pixel, and allocating the average to the hole pixel.

Before computing this average, the process may first compare metadata of the hole pixel to metadata of each of the surrounding pixels, and only use those of the surrounding pixels that have the same metadata as the hole pixel in the computation of the average. The metadata may include a material identifier of the pixel. A material identifier is semantic information assigning a material to a pixel.

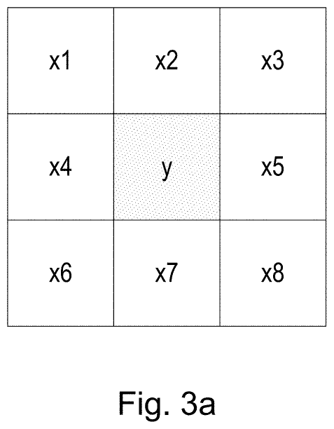

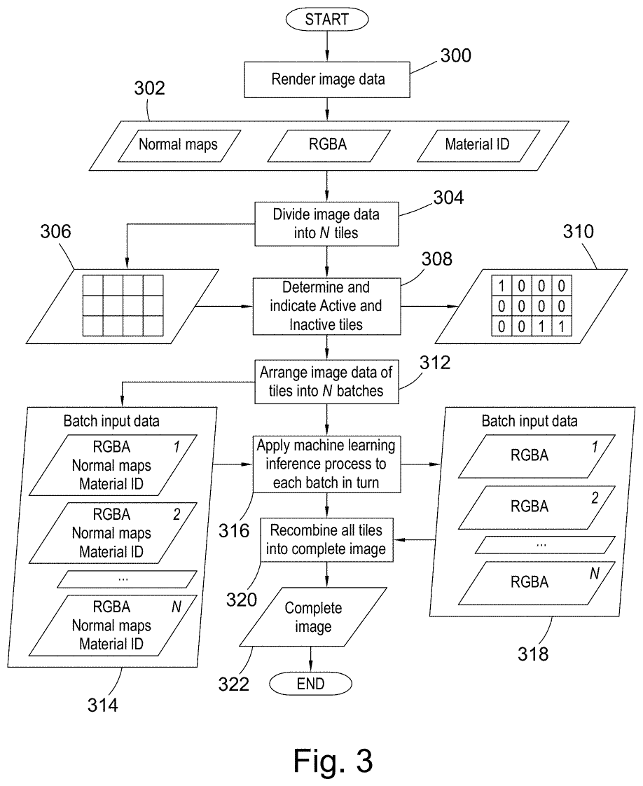

Referring to FIG. 3a, this figure shows a 3×3 kernel where n=8. A hole pixel y is in the centre of the kernel and there are eight surrounding pixels {x₁, . . . , x₈}. Other kernel sizes are possible, such as 5×5 and 7×7 kernels, depending on over how broad an area of the image the averaging is to be performed. In the context of image processing, a kernel is understood to be an array or matrix to be convolved with an image to alter the image. Weighting values or coefficients may be associated with the pixel values xₙ so that some have a greater or lesser effect on the average.

The averaging may be performed as follows. For each hole pixel y, the hole pixel y is filled according to an average RGB(y) of surrounding pixels which have the same material identifier as hole pixel y, the average calculated using the following equation:

$$RGB ( y ) = {\sum }_{x ∈ {Ω}_{{M}_{y}}} \frac{1}{\vert {Ω}_{{M}_{y}} \vert} RGB ( x ) ;$$

where RGB(x) is the RGB value of pixel x, M(x) is the material identifier of pixel x, Ω_{M}_{_{y}}={x ∈Ω_{y}|M(y)=M(x)}, x ∈Ω_{y} where Ω_{y}={x₁, . . . , xₙ} is the set of surrounding pixels around pixel y (see FIG. 3a), and Ω_{M}_{_{y}}={x ∈Ω_{y}|M(y)=M(x)}} means the set of pixels surrounding y such that that the material of those pixels are the same as the material of pixel y. M(y)=M(x) when the material identifier of the hole pixel y matches the hole identifier of pixel x.

The first process may include performing one or more morphological operations. Morphological operations can include an erosion operation and/or a dilation operation operating on the image data. Erosion removes pixels on boundaries in the image data and dilation adds pixels to boundaries in the image data.

If the tile is categorised as a “large hole” tile, the image data of that tile is passed to a machine learning inference process for processing. In FIG. 2, the machine learning process is referred to as “machine_learning_inference_process”. The machine learning process fills (216) the hole and outputs processed image data corresponding to a filled version of the large hole tile.

The machine learning process in FIG. 2 may be implemented using a data model. The data model may be an Artificial Neural Network (ANN) and, in some cases, a convolutional neural network (CNN).

ANNs (including CNNs) are computational models inspired by biological neural networks and are used to approximate functions that are generally unknown. ANNs can be hardware (neurons are represented by physical components) or software-based (computer models) and can use a variety of topologies and learning algorithms. ANNs can be configured to approximate and derive functions without a prior knowledge of a task that is to be performed and instead, they evolve their own set of relevant characteristics from learning material that they process. A convolutional neural network (CNN) employs the mathematical operation of convolution in in at least one of their layers and are widely used for image mapping and classification applications.

In some examples, ANNs usually have three layers that are interconnected. The first layer may consist of input neurons. These input neurons send data on to the second layer, referred to a hidden layer which implements a function and which in turn sends output neurons to the third layer. With respect to the number of neurons in the input layer, this may be based on training data or reference data that is provided to train the ANN.

The second or hidden layer in a neural network implements one or more functions. There may be a plurality of hidden layers in the ANN. For example, the function or functions may each compute a linear transformation of the previous layer or compute logical functions. For instance, considering that an input vector can be represented as x, the hidden layer functions as h and the output as y, then the ANN may be understood as implementing a function of using the second or hidden layer that maps from x to h and another function g that maps from h to y. So, the hidden layer's activation is f(x) and the output of the network is g(f(x)).

In order to train the data model to detect a characteristic associated with a feature of interest pertaining to an image, such as a hole, the following information may need to be provided to the data model:
(i) a plurality of training images, each training image having one or more holes of a certain type or dimension;
(ii) for a given training image among said plurality:
   one or more training inputs, such as a label for a feature of interest, associated with the given image; and
a training output identifying a specific type of infill, such as a particular colour or shading or feature to be applied to the image that is associated with the feature of interest pertaining to the label. In one example, a training image used to train the data model may be an incomplete image, for which a training input may be a binary mask image indicating where holes are in the training image. The training output may then be the completed image.

In another example associated with the present disclosure, the features of interest are holes that are to be filled in, with a label (training input) indicating a characteristic of the surrounding tiles or pixels or portions of the images such as “red” or “green lines” to apply or add as an infill to the hole in order to generate a completed image based on the its surrounding pixels. The training output in this example may be an indication that such as “90% of the surrounding pixels are closest to the frequency associated with the colour red, and therefore the infill for this hole should be red” or that “99% of the surrounding piles are filled with green diagonal lines, and therefore this infill should also be green diagonal lines”. Therefore, this indicates that the holes in the given training images are classified as being ones that are to be filled by a certain colour or characteristic based on the majority of its surrounding pixels. The values 90 and 99% are only provided as an example, and any threshold may be predefined for the data model.

Thus, after sufficient instances, the data model is trained to detect a feature associated with surrounding pixels of a feature of interest in the image, and apply a classification based on this. For instance, “this is recognised as a hole that requires a red infill” for a new live or real time input image to the trained data model.

A large number, for example hundreds or thousands, of training images of features of interest or each class of feature can be used for the training. In some embodiments, a computer data file containing the defined location of features of interest and associated labels for all the training images is constructed by either human input (also known as annotation) or by computerised annotation based on analysing the frequency of the colours on a defined spectrum.

An example of inputs provided to a trained ANN and the output received can be seen in FIG. 2a.

Input 1 represents an incomplete image to be filled, such as an RGB image.

Input 2 represents a binary mask image indicating where holes are present in the image input in 1.

Input 3 represents a second input, which may be metadata such as material ID.

The output of the trained ANN is then the completed image.

In one example, the ANN may operate based on using linear regression techniques, i.e. to extract and minimise the error until a suitable output is obtained. For example, this may be based on an advanced denoising convolutional autoencoder network, which may be used to create an output that is close to a true image.

In another example, the ANN used for image inpainting may be based on segmentation prediction network (SP-Net) and/or segmentation guidance network (SG-Net), which predict segmentation labels in holes first, and then generate segmentation guided inpainting results.

In another example the ANN may an inpainting system to complete images with free-form mask and guidance, based on convolutions learned from a significant number of images without additional labelling. Such network provides a learnable dynamic feature selection mechanism for each channel at each spatial location across all layers of the network. Such a network may also be adapted to use gated convolutions in place of regular convolutions. Further inputs such as material ID image channel and additional channels such as object outline etc. may be provided. As free-form masks may appear anywhere in images with any shape, such networks may also utilise a patch-based Gated Adversarial Network (GAN) loss (SN-PatchGAN).

In some other examples, it may be possible to assign a pre-trained classification to image features using the annotations or labels in the training input. Examples of such a network could be but are not limited to object detection using convolutional layers that are capable of performing feature extraction from the input images. This can be implemented by feature extraction algorithms such as R(Region) CNN, Fast-RCNN, Faster-RCNN, YOLO (You Only Look Once CNN), YOLOv3, and other derivatives including custom implementations designed with similar structures and written in a suitable programming framework.

The execution of the ANN routines would be typically completed by running the ANN on a suitable computing resource. The calculations could be performed on either the central processing unit (CPU) of the computer or a graphics processing unit (GPU) or a dedicated tensor processing unit (TPU) or a combination of any of the above. The location of the data files and any code/structure/weights for the ANN could be stored on the computing resource or accessed via the Internet, for example via a cloud storage platform.

The method repeats the filling steps until all the tiles which contain holes are determined (118) to have had their holes filled. The filled tiles are then recombined (120) into a completed image which does not contain holes. Where there are tiles (122) which were determined to not contain any holes to being with, the tiles absent holes are combined with the tiles which have been processed to form the completed image. The completed image (124) is therefore absent of holes.

The machine learning inference process requires more computing power to fill a hole of given size in a given time period than a non-machine learning process such as the first process or averaging process described above. However, the machine learning inference process provides a higher quality fill than the less complex, quicker non-machine learning process. Therefore, allocating larger, and therefore more obvious, holes in an image to the machine learning process and allocating smaller, less obvious holes to a non-machine learning process achieves a desirable balance between quality and performance so that a less powerful computer is better able to produce quality filled images in the same or less amount of time.

Referring to FIG. 3, image data (302) is generated, or rendered (300). The image data (302) includes RGBA values for each pixel of the image data, a set of normal maps, and a set of material identifiers. An RGBA value includes data on Red, Green, Blue, and opacity (known in the art as Alpha) values of the pixel. Normal maps include co-ordinate data defining a surface normal for adding detail to an image without adding polygons. Material identifiers are semantic data defining materials associated with pixels.

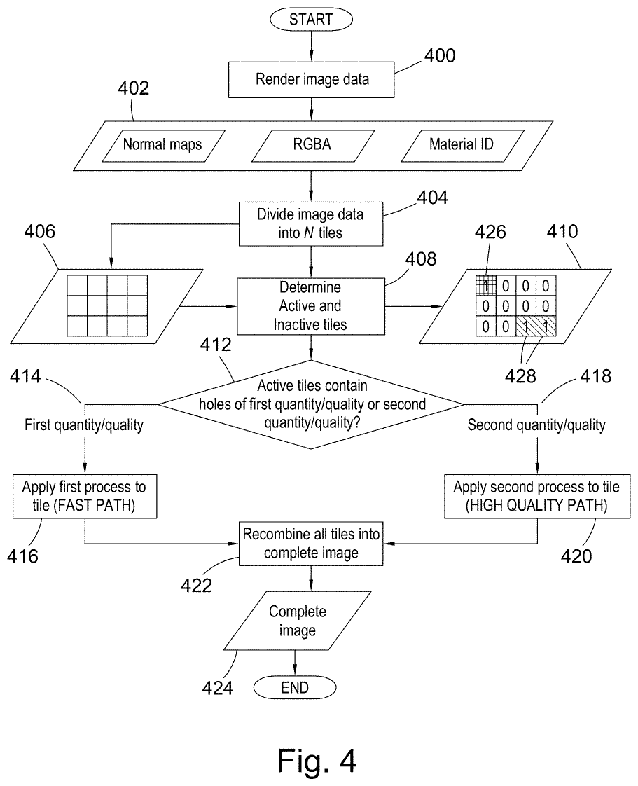

The image represented by the image data is divided (304), or split, into a plurality of tiles as in the first embodiment. In the example illustrated by FIG. 4, the image data (302) is split into twelve tiles (306).

The twelve tiles are examined for holes (308) and marked accordingly (310). Those determined to contain holes are designated “Active” and marked with a “1”. Those that do not contain holes are designated “Inactive” and marked with a “0”.

Three of the tiles are marked 1 meaning that those tiles have been determined (308) to contain holes. The other nine tiles are marked 0, meaning that those tiles have been determined to not contain holes. The binary marking in this example is arbitrary and other marking is possible.

In an embodiment, if a tile contains no holes, the input image in the input buffer (314) corresponding to that tile is copied directly into the output buffer (318).

If a tile contains one or more holes, the input tile is checked per-pixel and, if the original source image pixel was not a hole pixel, then the original pixel value is copied. If the source pixel is a hole pixel, then a pixel from a filled version of the tile is used.

In this embodiment therefore, tiles containing no holes are directly copied from the input to the output buffer, and tiles that contain holes are copied pixel by pixel where pixels present in the image are copied and hole pixels are filled by a filling process.

Image data corresponding to each tile is provided as input to a machine learning inference process. In FIG. 3, the image data is shown arranged and provided (312) in an input buffer (314) containing a batch of N items, numbered 1 . . . N, which respectively correspond to the image data of the tiles. In other words, there are N tiles and one batch of input data, where the buffer is large enough to accommodate all tiles. In this example, N=12. The machine learning inference process processes (316) the image data of each tile in turn to fill holes in the image data and produces an output batch in output buffer (318) of N processed image data. By providing the image data in batches, the processing of each batch, and therefore the filling of each tile, can be performed in parallel.

It is to be noted that the input buffer may not be large enough to accommodate all tiles to be processed and that multiple batches of input data may need to be passed to the input buffer. For instance, where there are 12 input tiles of which 3 are to be processed, and the batch size is 4, then we would have 1 batch of 3 tiles (one empty input tile). If the batch size was 2, then we would have 2 batches: 1 batch of 2 tiles and 1 batch of 1 tile (and one empty tile).

The processed image data is then reconstituted (320) into a completed image (322). As shown in FIG. 3, only the Active tiles containing image data have holes to be filled. In the reconstitution step, the tiles which were processed to fill holes of image data therein are combined with the tiles which were not processed to form the completed image.

Referring to FIG. 4, an embodiment of the present disclosure is shown. Image data (402) is generated or rendered (400). The image data includes RGBA values for each pixel of the image data, a set of normal maps, and a set of material identifiers.

The image data is divided (404), or split, into tiles (406). The tiles are analysed (408) to determine which tiles contain holes and which do not. The tiles are marked accordingly (410) in a similar manner to that described with reference to FIG. 3.

Qualities and/or quantities of the holes that are found are determined (412). The quantities and/or quantities are chosen prior to executing the method according to whether a high-quality, resource-intensive process is required for filling the holes, or whether a lower-quality, less resource-intensive process is suitable.

The dividing (404) step of FIG. 4 splits the image data into a 4×3 grid of 12 total tiles. In this embodiment, three tiles are determined (408) to contain holes and are marked with a “1” to indicate the presence of holes. Tiles determined (408) not to contain holes are marked “0”.

A tile (426) in the top-left of the grid (410), marked 1, is determined to contain a hole having an associated first quantity and/or quality, and two other tiles (428), specifically two tiles at a lower edge and right-hand side of the grid, are determined to have an associated second quantity and/or quality which is different to the first quantity and/or quality. The first quantity/quality is indicated with square cross-hatching and the second quantity/quality is indicated with diagonal hatching.

The method of FIG. 4 includes passing (414) any tiles determined (412) to contain holes having an associated first quantity and/or quality to a first filling process (416), and includes passing (418) any tiles determined to contain holes having an associated second quantity and/or quality to a second filling process (420) different to the first filling process. This allows the method to be adapted to fill holes of different sizes and/or types by filling processes which are appropriate to those hole sizes and/or types.

In the embodiment of FIG. 4, the first filling process (416) is referred to as the “Fast Path”, and the second filling process (420) is referred to as the “High Quality Path”.

The “Fast Path” process (416) takes the top-left Active tile (426), previously identified as having an associated first quantity and/or quality, as input. The “Fast Path” process (416) fills the hole in the tile and outputs the filled tile.

The “High Quality Path” (420) takes the bottom two Active tiles (428), previously identified as having an associated second quantity and/or quality, as input. The “High Quality Path” process fills the holes in the tiles and outputs the filled tiles.

The “Fast Path” process (416) is a filling process which fills holes in a less resource-intensive manner than the “High Quality Path” process (420), and therefore fills holes more quickly. However, the “High Quality Path” process (416) fills the holes to a higher quality than the “Fast Path” process (420).

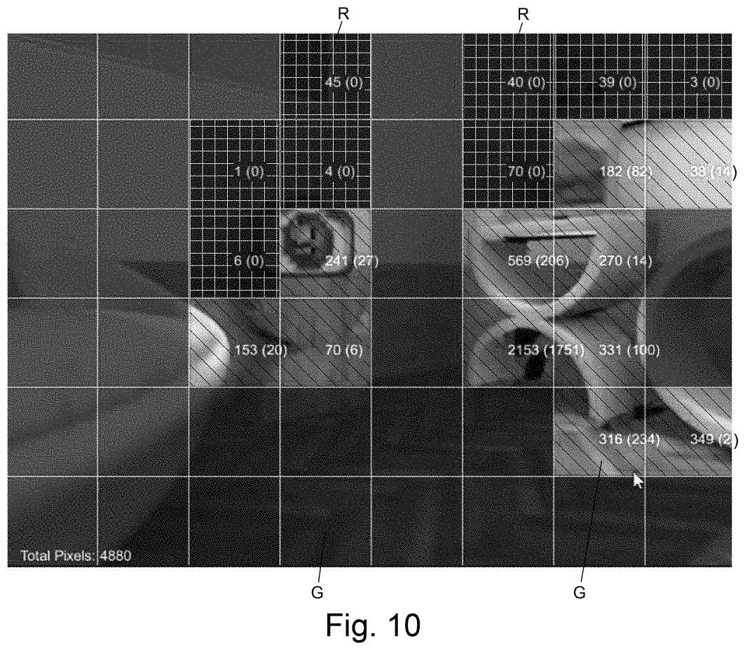

The “Fast Path” process (416) may include the first process (112) of FIG. 10r the averaging process (212) discussed with reference to FIG. 2. The “High Quality Path” process (420) may include the machine learning process (216) discussed with reference to FIG. 2.

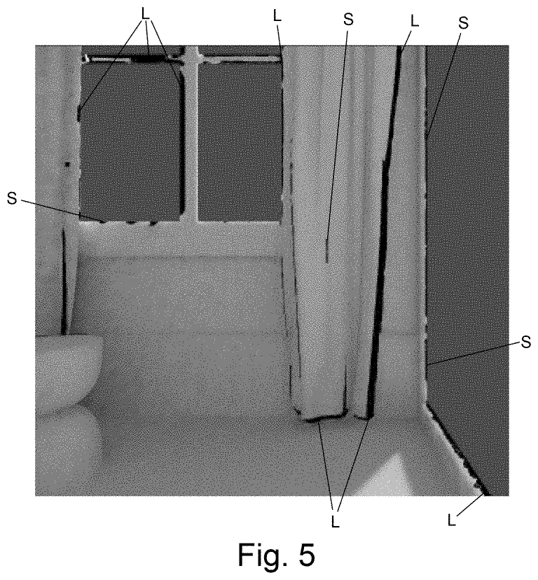

The determination step (412) of FIG. 5 may include determining that the first quantity is a hole size less than a first threshold size, and that the second quantity is greater than a second threshold size, in the same manner as discussed with reference to FIG. 2.

The determination step (412) may include passing tiles determined to contain holes below the first threshold size to the “Fast Path” process (416) and tiles determined to contain holes above the second threshold size to the “High Quality Path” process (420).

Once all Active tiles, i.e. those marked “1”, have been processed to fill the holes, the tiles which were processed are combined with the tiles previously marked “0” to complete the image.

Referring to FIGS. 5 to 10, examples of hole identification and tile categorisation according to embodiments of the present disclosure will now be described.

FIG. 5 shows an image to be completed. The medium-grey shaded areas of the image correspond to holes, where in this case the holes are where image data is missing from the image. Holes deemed to be large are indicated L, and holes deemed to be small are indicated S.

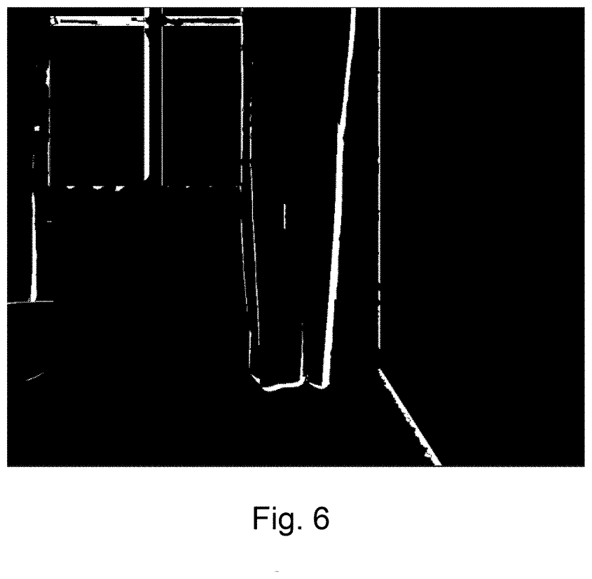

FIG. 6 shows a mask of the image of FIG. 5, where white areas of the mask correspond to the holes and black areas to the rest of the image. In FIGS. 5 and 6, holes of different sizes and shapes of holes are evident.

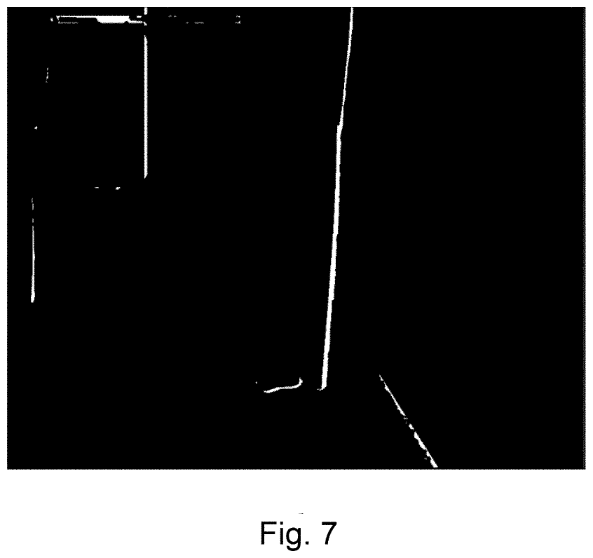

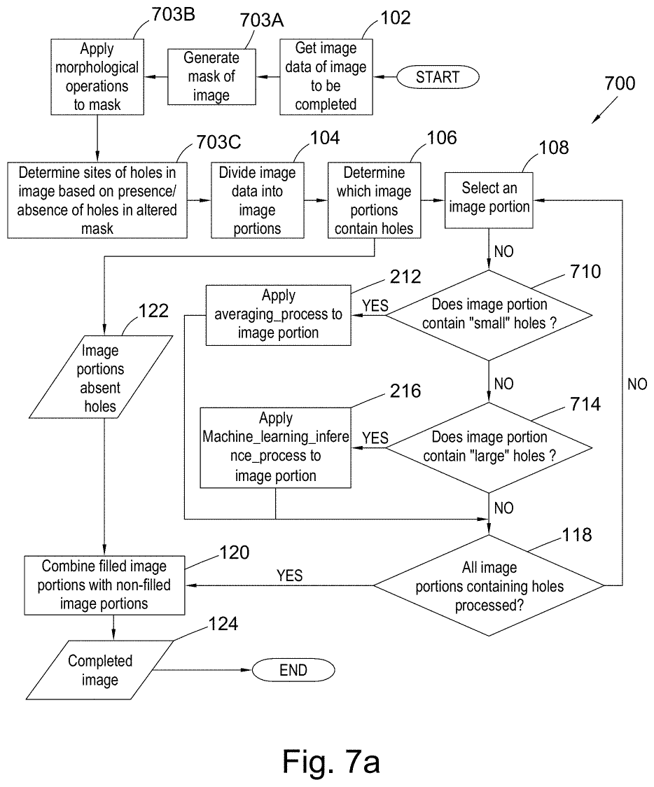

FIG. 7 shows a mask of the image of FIG. 6 after an alteration step. In this embodiment, the alteration step includes an erosion operation, though other morphological operations and combinations thereof are possible. The alteration step can be seen to have eliminated the narrower, smaller holes S evident in the mask shown in FIG. 6, leaving only wider, larger holes. The holes in the image of FIG. 5 are categorised according to whether the holes in the mask of FIG. 6 disappear or remain after the alteration step. If the holes disappear, that is they are absent from the altered mask shown in FIG. 7, the holes are categorised as “small”. If the holes remain, that this they are present in the altered mask of FIG. 7, the holes are categorised as “large”. Different filling processes can then be applied based on the categorisation of the holes.

Referring to FIG. 7a, a method (700) for completing an image according to an embodiment using the masking and alteration steps described above with reference to FIGS. 6 and 7 will now be described. The method of FIG. 7a is similar to FIGS. 1 and 2, where differences are marked with like numerals increased by 700. A mask of the image data to be completed is generated (703A). The mask may be a binary mask, where hole pixels are represented by a zero and non-hole pixels are represented by a one. An example of such a mask is shown in FIG. 7.

The mask is then altered using morphological operations (703B). The number and/or type of operations are chosen to suit the hardware performing the filling processes and/or based on user requirements. For example, if the hardware performing the filling is comparatively less powerful than other hardware, several erosion operations may be performed to remove from the mask all but the largest of holes. This causes most of the holes to be categorised as “small” holes, so that the majority of filling performed is of the simple, less computationally expensive type and decreasing the amount of complex, high-quality filling required. On the other hand, if higher-quality filling is required, fewer erosion operations may be applied to the mask. The categorisation is described in more detail below.

Once the mask has been altered to generate an altered mask, a hole size determination step (703C) is performed. The altered mask is examined for hole presence and compared to the original mask or the original image. For each hole present in the original mask or original image, the altered mask is examined to determine whether that hole remains present in the altered mask. If the altered mask also contains the hole, the hole in the original image is categorised as a “large” hole, as the morphological operation(s) applied did not eliminate the hole from the mask during the alteration step.

The image data is then divided (104) into tiles. The tiles are examined to determine (106) which tiles contain holes. A tile determined to contain a hole is selected (108).

The computer device determines (710) whether the tiles contains “small” holes based on the outcome of the previous determination step (703C). If the tile contains small holes, then the averaging_process is applied (212) to fill the small holes.

The computer device determines (714) whether the tiles contains “large” holes based on the outcome of the previous determination step (703C). If the tile contains large holes, then the machine_learning_inference_process is applied (216) to fill the large holes.

The method repeats the filling steps until all the tiles which contain holes are determined (118) to have had their holes filled. The filled tiles are then recombined (120) into a completed image which does not contain holes. Where there are tiles (122) which were determined to not contain any holes to being with, the tiles absent holes are combined with the tiles which have been processed to form the completed image. The completed image (124) is therefore absent of holes.

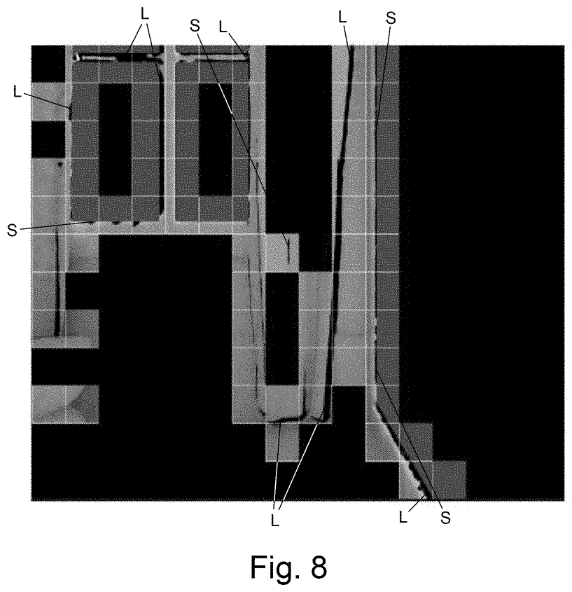

FIG. 8 shows the image of FIG. 5 having been split into tiles. The tiles in FIG. 8 that are determined to not include holes are coloured black, and the tiles containing holes are unaltered. FIG. 8 shows sixty-nine Active tiles. That is there are sixty-nine tiles containing holes to be filled. Sixty-nine tiles therefore require processing to fill the holes and complete the image.

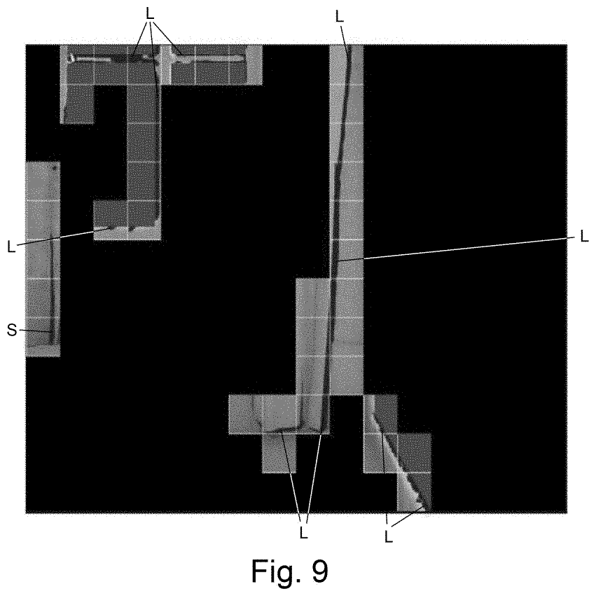

FIG. 9 shows the image of FIG. 5 having been split into tiles and having undergone a first filling step, such as the first filling step described with reference to FIG. 2. The first filling step has filled narrower, smaller holes S so that only larger, wider holes L remain. Relative to FIG. 8, more tiles of FIG. 9 are coloured black due to the filling of several narrower, smaller holes by the first filling step so that those tiles no longer contain holes. In this embodiment, there are thirty-seven Active tiles remaining. Therefore, relative to the embodiment of FIG. 7 only thirty-seven tiles require additional processing to fill the holes and complete the image, representing a computational saving proportional to 37 tiles' worth of holes.

Referring to FIG. 10, an image is shown having been divided into tiles. Black tiles are tiles identified as not containing any holes. Tiles marked with square cross-hatching R are tiles identified as containing “small” holes. Tiles marked with diagonal hatching G are tiles identified as containing “large” holes.

Shown in each tile of FIG. 10 is a pair of numbers in the form X(Y). In each tile, the number X represents the number of hole pixels in the original tile and Y represents the number of hole pixels in the altered mask tile, i.e. the mask of the original image, having been processed by, for example, applying a single erosion operation to the tile. When Y=0 and X>0, that is the alteration of the mask caused the hole in the mask to disappear, then the original tile contains a small hole and is filled using a faster, more efficient filling process. When Y>0, that is the alteration of the mask did not cause the hole in the mask to disappear, then the original tile contains a large hole and is filled with a higher quality filling process, such as the machine learning process described above.

Square-hatched tiles R (representing Red) are categorised as requiring “fast” processing, because they contain “small” holes. The fast processing may include the first filling process described above with reference to FIG. 2.

Diagonal-hatched tiles G (representing Green) are categorised as requiring high-quality filling, because they contain “large” holes. The high-quality filling may include the machine learning inference process described above with reference to FIG. 2.

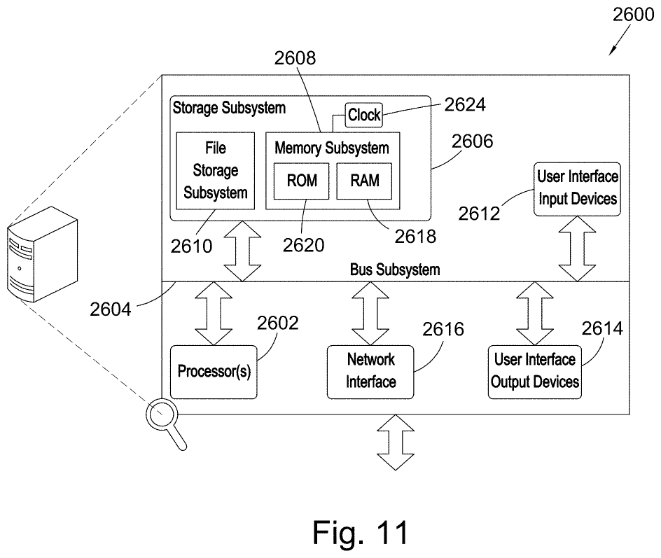

Turning now to FIG. 11, there is provided an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as a virtual reality headset or a client terminal for receiving an image to be rendered, where processing of the image is done remotely

The computing device is associated with executable instructions for causing the computing device to perform any one or more of the methodologies discussed herein. The computing device 2600 may operate in the capacity of one or more processors for implementing a data model, such as an ANN or CNN, for performing machine learning operations, and/or may operate in the capacity of a processor for performing image averaging techniques mathematically, for carrying out the methods of the present disclosure. In alternative implementations, the computing device 2600 may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

Thus, computing device 2600 may be a portable computing device, a personal computer, or any electronic computing device. As shown in FIG. 11, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 11 is intended only as a specific example for purposes of illustrating the preferred embodiment of the device. Many other configurations having more or fewer components than the system depicted in FIG. 11 are possible.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. The mere fact that certain measures are recited in mutually different dependent claims does not indicate that a combination of these measures cannot be used to advantage.

1. A computer-implemented method for completing an image, the method comprising:
dividing image data of an image to be completed into a plurality of image portions;
applying a first filling process to fill a first image portion comprising a first hole, the first hole associated with a first quantity and/or a first quality;
applying a second filling process to fill a second image portion comprising a second hole, the second hole associated with a second quantity different to the first quantity and/or a second quality different to the first quality, the second process being different to the first process; and
combining the filled first and second image portions to complete the image.

2. The computer-implemented method of claim 1, comprising generating a mask of the image to be completed, performing at least one morphological operation on the mask to generate an altered mask, and determining to apply the first filling process and the second filling process based on respective first and second quantities and/or qualities of the altered mask.

3. The computer implemented-method of claim 2, comprising determining to apply the first filling process on a first hole based on an absence of a hole corresponding to the first hole in the altered mask, and determining to apply the second filling process on a second hole based on a presence of a corresponding hole in the altered mask.

4. The computer-implemented method of claim 2, wherein the at least one morphological operation includes erosion and/or dilation.

5. The computer-implemented method of claim 1, comprising applying the first filling process to the first image portion in response to a determination that the first hole has a dimension smaller than a first threshold value.

6. The computer-implemented method of claim 1, comprising applying the second filling process to the second image portion in response to a determination that the second hole has a dimension larger than a second threshold value.

7. The computer-implemented method of claim 1, wherein the first filling process includes filling a pixel of a hole of the first type according to an average of surrounding pixels.

8. The computer-implemented method of claim 7, comprising determining the average using surrounding pixels having a material identification which is the same as the pixel to be filled.

9. The computer-implemented method of claim 7, wherein the determination of the average includes weighting values of the surrounding pixels to be averaged.

10. The computer-implemented method of claim 1, wherein the second filling process includes a machine learning inference process.

11. The computer-implemented method of claim 10 wherein the machine learning inference process is implemented by a data model, said data model or associated with an artificial neural network (ANN).

12. The computer-implemented method as claimed in claim 11 wherein the ANN is a convolutional neural network (CNN).

13. The computer-implemented method of claim 1, further comprising combining the filled image portions with image portions that were not filled by the first and second processes.

14. A computing device comprising one or more processors that are associated with a memory, the one or more processors configured with executable instructions which, when executed, cause the computing device to carry out the following method:
dividing image data of an image to be completed into a plurality of image portions;
applying a first filling process to fill a first image portion comprising a first hole, the first hole associated with a first quantity, and/or a first quality;
applying a second filling process to fill a second image portion comprising a second hole, the second hole associated with a second quantity, different to the first quantity and/or a second quality different to the first quality, the second process being different to the first process; and
combining the filed first and second mage portions to complete the image.

15. The computing device of claim 14, wherein the device is configured to receive the image data of the image to be completed from a server, such as a cloud-based image rendering server, and/or an image capture device or processor associated therewith.

16. The computing device of claim 14, wherein the hole of the received image data corresponds to an occluded area.

17. The computing device of claim 14, wherein the device is a virtual reality device, such as a virtual reality headset.
